(19) United States
(12) Patent Application Publication
(10) Pub. No.: US 2026/0341026 A1
(43) Pub. Date: Oct. 29, 2026

(54) Attribute-Based Outlier Detection System Without Predefined Categories

(71) Applicants: Ching-Tien Ho, San Jose, CA (US); James Jie-ming Gu, San Ramon, CA (US); Jeremy Huey, Cupertino, CA (US)

(72) Inventors: Ching-Tien Ho, San Jose, CA (US); James Jie-ming Gu, San Ramon, CA (US); Jeremy Huey, Cupertino, CA (US)

(21) Appl. No.: 19/190,434

(22) Filed: Apr. 25, 2025

(51) Int. Cl. G06V 20/52; G06V 10/44; G06V 10/74; G06V 40/10

(52) U.S. Cl. CPC G06V 20/52; G06V 10/44; G06V 10/761; G06V 40/10

(57) ABSTRACT

A system and method for detecting anomalous individuals in image data without relying on predefined classes or training labels. The method involves extracting a set of descriptive attributes from individuals in a set of images using prompt-engineered queries to a large language model or multimodal model. Each individual is represented as a structured data profile, and statistical or distance-based methods are used to compute how different each profile is from others. Those that significantly differ are marked as outliers for further evaluation. The method allows for unsupervised or semi-supervised anomaly detection that is robust to unseen data and contexts.

### FIELD

The invention relates to data analysis and anomaly detection, and more particularly, to systems for identifying unusual individuals or events in image data using attribute-based clustering and large language models.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The present invention relates to the field of anomaly detection in security systems, and more particularly to systems and methods for using prompt engineering and large language models (LLMs) to detect anomalies such as homeless individuals in images captured by security devices. The invention leverages the power of artificial intelligence (AI) to enhance security applications, improving the accuracy and efficiency of detection systems in dynamic environments.

The use of AI-driven security systems has been gaining momentum in various industries. In previous innovations, inventors have developed several related technologies that complement the current invention and provide a foundation for its capabilities. These innovations include systems for autonomous robots, crime detection, and threat mitigation, which rely heavily on image analysis and AI algorithms. Examples of these innovations are briefly described as follows:

Mannequin robot security system: Inventors have developed a Security Robot System consisting of an autonomous vehicle, a mannequin mounted on the vehicle, and various sensors and devices for autonomous navigation, security patrolling, and communications. The system uses AI to interpret its surroundings and identify potential security threats. This technology serves as a precursor to the current invention by demonstrating how AI systems can enhance the functionality of mobile security robots.

Crime Detection and Deterrence System (CDDS): Inventors have developed a Crime Detection and Deterrence System (CDDS), an AI-based multimodal Large Language Model (LLM) that automatically detects potential threats by analyzing audio and video inputs from security robots. The AI engine functions as a chatbot, allowing the robot to interact with individuals while determining their intent. This system laid the groundwork for the prompt engineering techniques used in the present invention to detect and classify anomalies, such as identifying homeless individuals in images.

Robotic Arm and Water Cannon System: Inventors have developed a cost-effective mechanism for deterring crime using a robotic arm and water cannon system mounted on security robots. These systems work together to deploy streams of water to deter individuals who may pose security risks. This invention further enhances the security capabilities of autonomous robots, complementing the anomaly detection systems discussed in the current invention.

Security System with Humanoids and Drones: The inventors have explored the use of humanoids and drones in combination with vehicles for security surveillance and safety inspections. The integration of these robotic systems offers dynamic approaches for anomaly detection and response, extending the capabilities of our current invention for use in a variety of environments.

Theater of Security Robot Operations: The inventors have proposed a dynamic team of robots with the ability to reconfigure and coordinate within a hierarchy, optimizing their deployment in emergency or disaster scenarios. This invention highlights the flexibility and scalability of AI-based systems, principles that are relevant to the real-time adaptability of the current invention's anomaly detection capabilities.

Lidar Optimization: The inventors have introduced a LiDAR optimization algorithm for autonomous vehicles, enabling precise navigation and obstacle detection. This work in sensor fusion and object recognition directly informs the current invention's capabilities in processing image data for anomaly detection.

Security Robot with Water Canister: The inventors have proposed integration of water canisters with security robot vehicles. This patent addresses practical aspects such as the placement, deployment, and control of water canisters on autonomous security robots. These advancements are linked to the detection and response capabilities of the present invention, where security robots are used to assess and interact with detected anomalies.

The current invention builds upon these foundational technologies described above, specifically focusing on anomaly detection through prompt engineering. By using large language models (LLMs) to extract differentiating attributes from images, such as clothing, posture, and location, the present invention classifies individuals in security environments and identifies anomalies, such as homeless individuals. The ability to fine-tune these models based on location and time further enhances the accuracy and adaptability of the detection system, ensuring that the security robots can effectively monitor and respond to different environments and scenarios.

### SUMMARY

This invention discloses a system for detecting outliers in image-based data without relying on predefined categories or class labels. The method leverages prompt-engineered queries to a language model to extract descriptive attributes from visual representations of individuals.

Each individual is converted into a structured data profile composed of these attributes, and statistical or distance-based algorithms are applied to determine which profiles significantly deviate from the rest. By focusing on relative differences rather than fixed labels, the system is capable of performing unsupervised or semi-supervised anomaly detection, making it ideal for environments where potential anomalies are not known in advance.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a flowchart of the anomaly detection process of the present invention;

FIG. 2 shows an example of an annotated image from the dataset with labeled attributes;

FIG. 3 shows a diagram of the decision tree classification algorithm of the present invention;

FIG. 4 shows an example of the prompt engineering process for attribute extraction;

FIG. 5 shows the anomaly detection algorithm for identifying outliers in the dataset in the present invention;

FIG. 6 shows an algorithm for customization of detection models based on location and time;

FIG. 7 shows a process for analyzing and correcting false negatives to improve model accuracy;

FIG. 8 shows a system architecture diagram of the anomaly detection and robot interaction framework;

FIG. 9 shows an interaction flow between the security robot and the outlier person; and

FIG. 10 shows a unified system architecture for attribute-based anomaly detection and robot response.

### DETAILED DESCRIPTION

The following description is merely exemplary in nature and is in no way intended to limit the disclosure, its application, or uses. It should be understood that steps within a method may be executed in different order without altering the principles of the present disclosure unless otherwise specified. As used herein, the term module may refer to an Application Specific Integrated Circuit (ASIC), an electronic circuit, a processor (shared, dedicated, or group) and memory that execute one or more software or firmware programs, a combinational logic circuit, and/or other suitable components that provide the described functionality.

The primary innovation of the present invention lies in the application of prompt engineering to the task of anomaly detection. Specifically, the invention demonstrates how prompts can be structured to identify homeless individuals using visual attributes such as clothing, posture, and location cues that distinguish them from the general population. This approach leverages the capabilities of large language models (LLMs), such as GPT, to detect and classify images based on these distinguishing features.

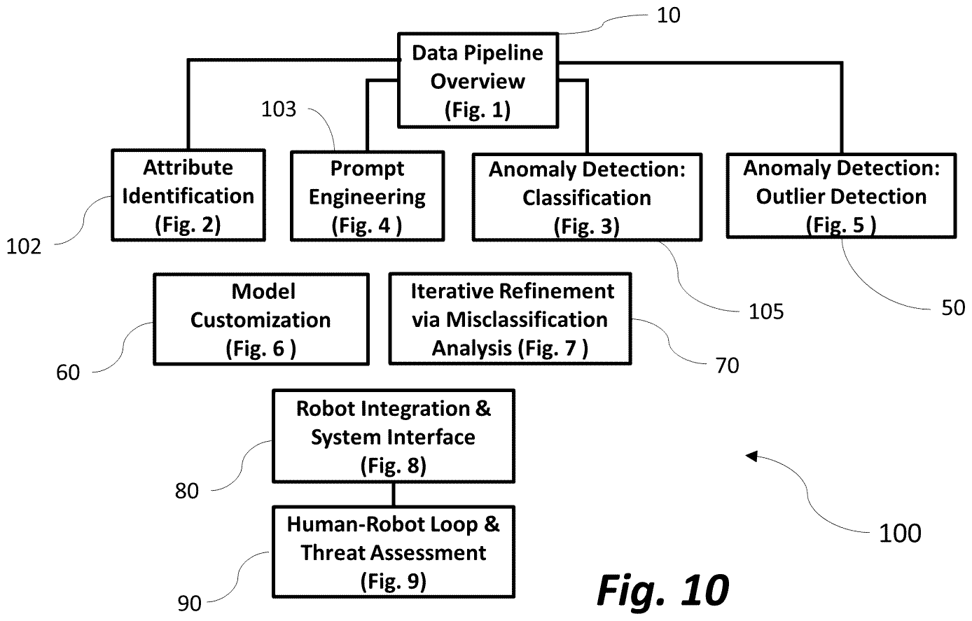

The overall system architecture embodied for the present invention is illustrated in FIG. 10 which contains the various blocks of processes as well as modules which will be made clear by referring to the explanation of the respective Figures, as described below.

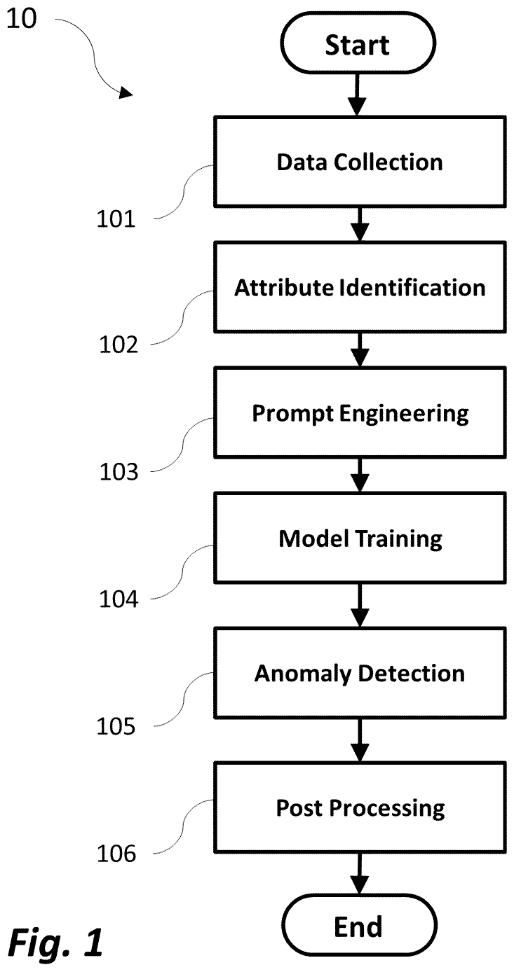

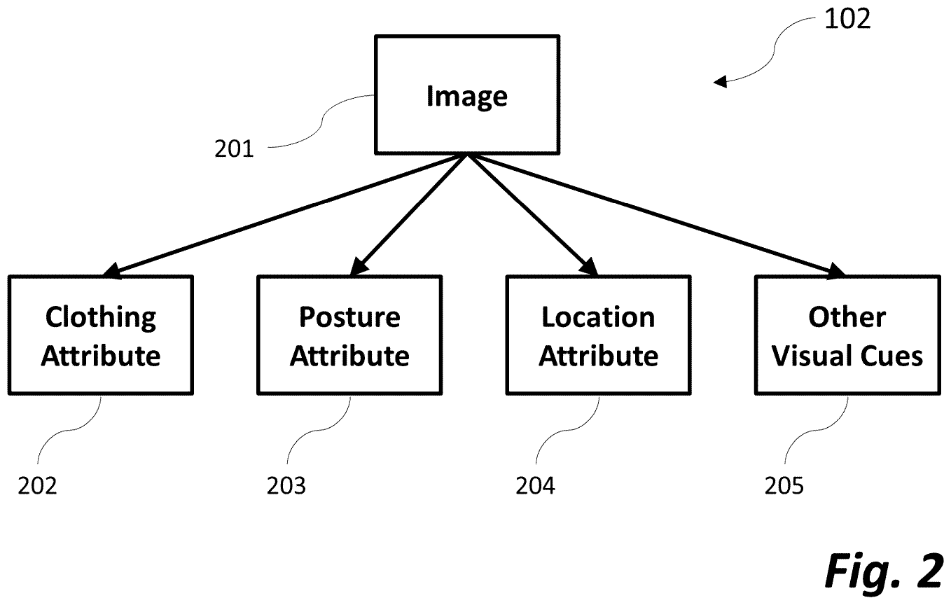

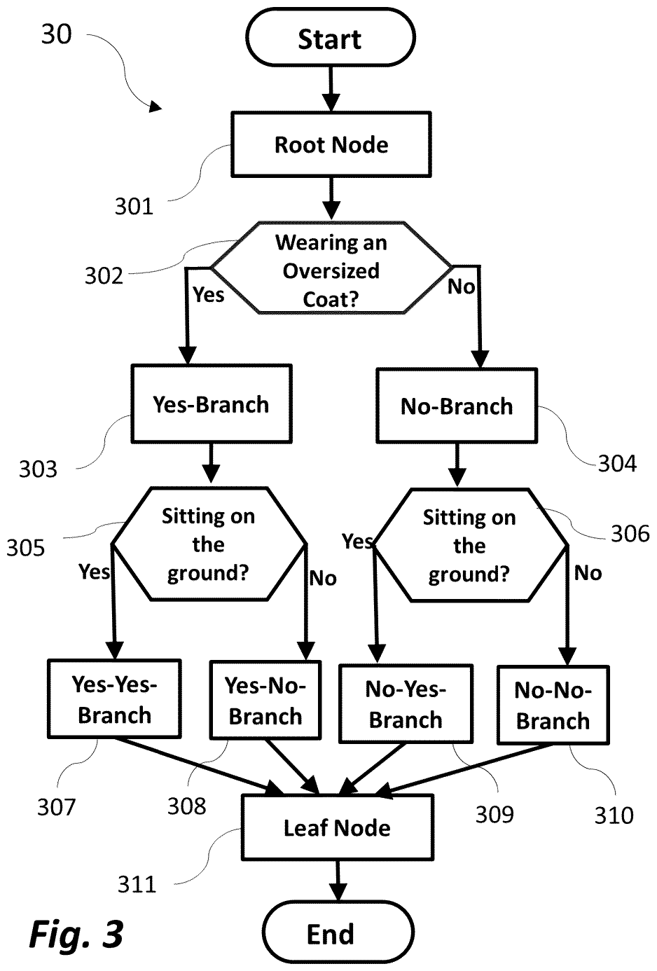

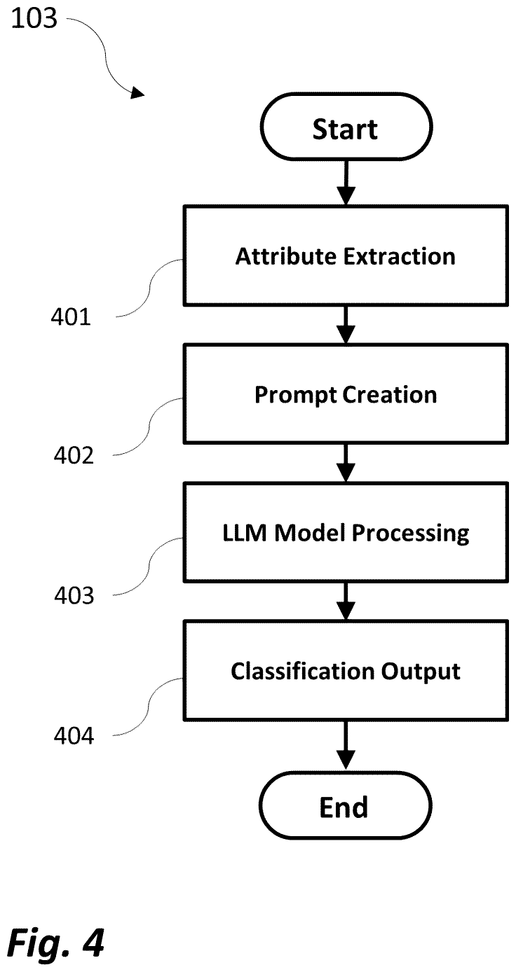

FIGS. 1 through 9 collectively illustrate an end-to-end framework for anomaly detection powered by prompt-engineered large language models and robotic interaction systems. The overall process is outlined in FIG. 1, which introduces the six-stage anomaly detection pipeline. The attribute identification stage (Block 102 in FIG. 1) is expanded in FIG. 2, detailing the annotation and visual labeling of key features. Prompt engineering (Block 103) is further elaborated in FIG. 4, showing how structured prompts are designed to guide LLM-based models. The application of real-world images to the pre-trained anomaly detection model (Block 105) is illustrated through the decision tree structure in FIG. 3.

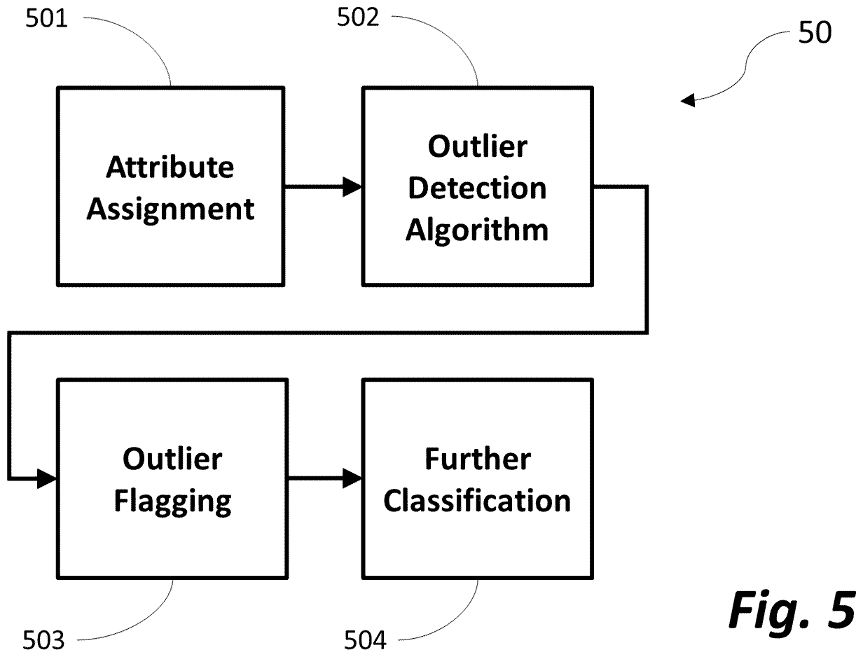

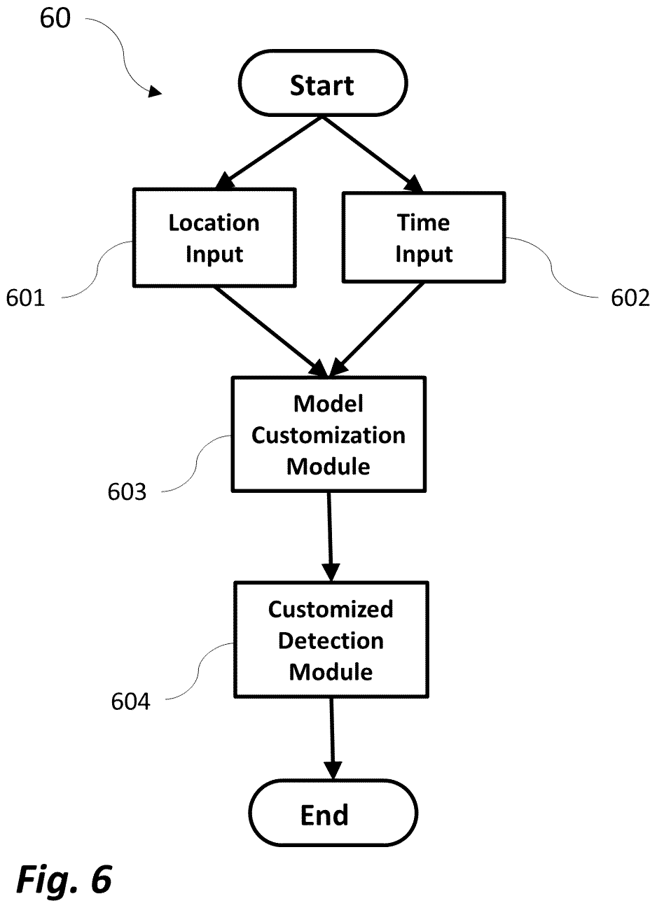

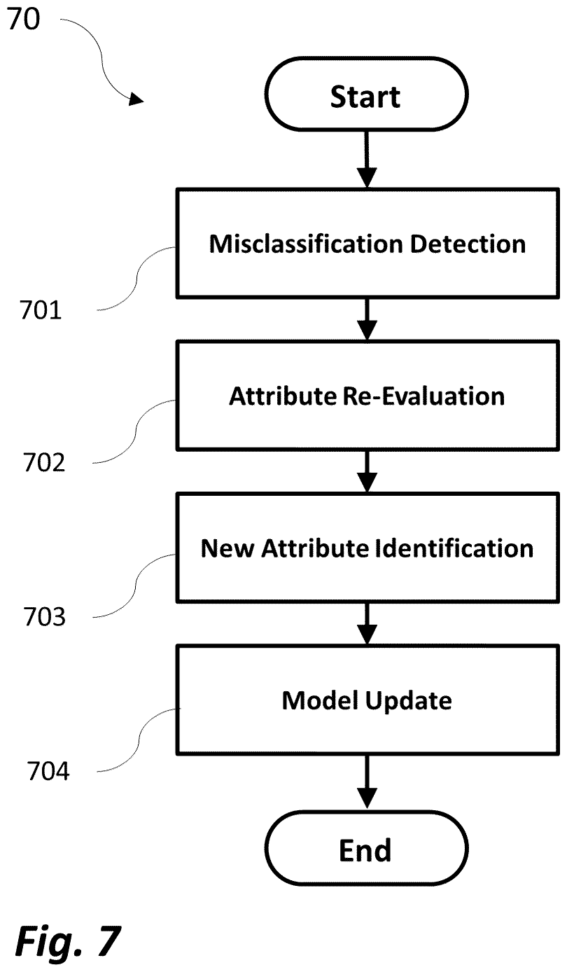

FIG. 5 extends the invention beyond predefined anomaly groups (e.g., homeless individuals, armed suspects) to support unsupervised outlier detection when the anomalous class is unknown in advance. FIG. 6 introduces model customization, allowing the system to adapt to location-specific and time-sensitive variables. FIG. 7 presents an iterative refinement loop that improves detection accuracy through systematic analysis of false positives and false negatives.

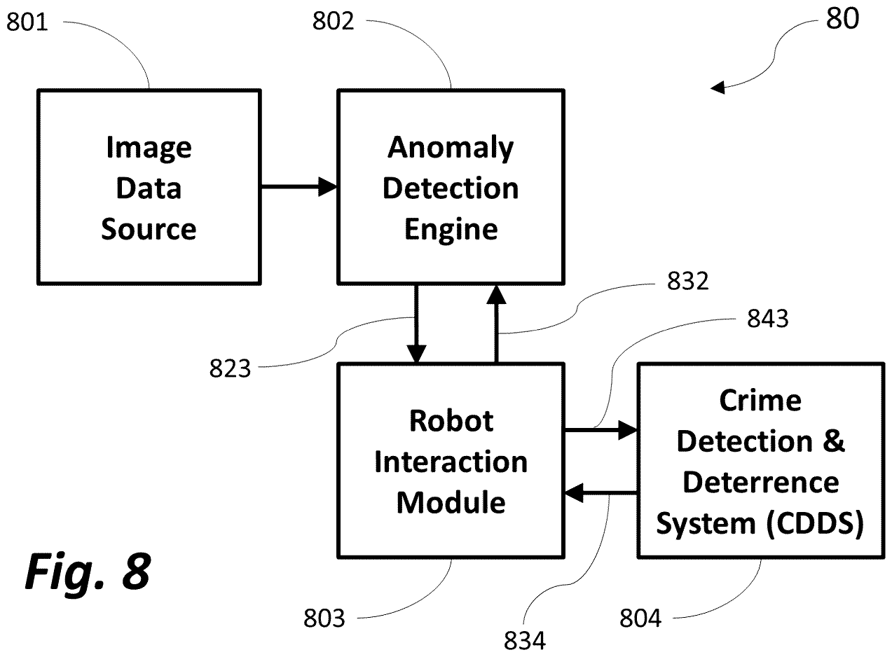

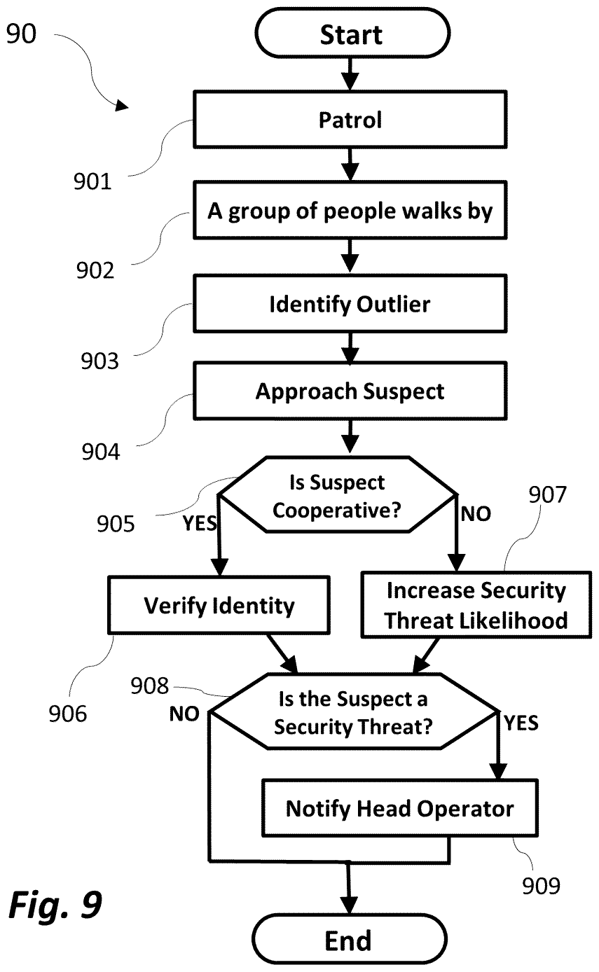

Once deployed, the anomaly detection system interfaces with autonomous security robots for real-time monitoring and engagement (FIG. 8). The robots leverage anomaly detection outputs to identify outlier individuals, initiate interaction, and respond based on behavioral analysis performed by the Crime Detection and Deterrence System (CDDS). FIG. 9 expands this interaction into a detailed operational flow, outlining patrol routines, identity verification, cooperation assessment, and risk analysis. Together, these components form a cohesive framework for intelligent, human-machine collaboration in public safety and security applications.

The following paragraphs describe how to train large language models to detect security anomalies such as images of homeless individuals.

Referring now to FIG. 1, a flowchart of the anomaly detection process executed in Block 10 using large language models under the present invention is shown. The flowchart illustrates the core steps in training a LLM-based system for anomaly detection, specifically aimed at identifying homeless individuals in visual data. The process includes six main components as described in the following paragraphs.

First, Data Collection (Block 101): A diverse dataset is gathered containing images of both homeless and non-homeless individuals. These may be sourced from online databases, surveillance footage, or real-world data collection efforts. Each image is labeled using predefined criteria to create a structured training set;

Second, Attribute Identification (Block 102): Key differentiating features, such as clothing style, posture, and contextual location, are extracted and labeled. These attributes form the foundation for guiding the model's attention;

Third, Prompt Engineering (Block 103): Prompts are carefully constructed to focus LLM on the identified attributes during image processing. These prompts translate visual features into structured input that the language model can reason about;

Fourth, Model Training (Block 104): Using the labeled dataset and engineered prompts, the LLM model is trained to associate combinations of attributes with the classification of “homeless” or “not homeless.” Classification rules or decision boundaries are learned implicitly or explicitly during this process;

Fifth, Anomaly Detection (Block 105): Once trained, the model is deployed to classify new, unlabeled images. It uses the learned attribute patterns to detect individuals who differ significantly from the baseline population, flagging potential cases of homelessness; and

Sixth, Post-Processing (Block 106): Misclassifications, both false positives and false negatives, are reviewed. These cases inform the identification of new or underrepresented attributes, which are then fed back into the system to retrain and refine the model in an iterative loop.

To train LLM for anomaly detection, a diverse and representative image dataset is essential. As introduced in FIG. 1, Attribute Identification (Block 102) aims to find key differentiating features, such as clothing style (e.g., oversized or layered garments), posture (e.g., sitting or lying on the ground), and contextual location (e.g., sidewalks or alleyways). These attributes form the foundation for guiding the model's attention.

Referring now to FIG. 2 for more details on Attributes Identification with a drilled down view of Block 102, it gives an example of an annotated image from the dataset, highlighting key visual attributes such as clothing, posture, location, and other distinguishing cues. These annotations serve as training signals, guiding the model to recognize and classify relevant features associated with homelessness. The present section provides a more detailed explanation of the Attribute Identification process (Block 102 in FIG. 1), using FIG. 2 for illustration.

FIG. 2 shows a sample image (Block 201) from the training dataset that includes both regular individuals and individuals experiencing homelessness. The image is annotated to highlight the various key attributes such as clothing, posture, location and other visual cues as described below:

Clothing (Block 202): Examples include “dirty oversized coat” or “hooded jacket.” These descriptors help differentiate between typical attire and clothing patterns more commonly associated with homelessness;

Posture (Block 203): Examples include “hunched over” or “sitting on the ground.” Body posture can often reflect certain conditions or behaviors relevant to the classification task;

Location (Block 204): Examples include “sitting on a park bench” or “standing in an alley.” Environmental context provides valuable cues for distinguishing individuals based on their surroundings; and

Other Visual Cues (Block 205): Additional distinguishing features may include grooming-related indicators such as long or unkempt hair, overgrown facial hair (e.g., beards, mustaches), or lack of visible hygiene. Contextual clues may also be considered, such as the presence of personal belongings in non-residential areas or objects like shopping carts in locations without nearby retail establishments.

These annotated attributes form the basis for training the model to differentiate between homeless and non-homeless individuals. By consistently labeling and structuring these visual indicators, the system can more accurately learn patterns and apply them during classification and anomaly detection.

The operation of Anomaly Detection (Block 105) is explained in more detail with reference to FIG. 3 below. Once the attributes have been identified, the system applies a decision tree algorithm to classify images as either “Homeless” or “Not Homeless”. This step involves applying the model trained in Block 104 to real-world, non-labeled data. In other words, the pre-trained anomaly detection model is executed using classification algorithms, such as a decision tree-based method.

FIG. 3 (Block 30) illustrates a flowchart of the decision tree algorithm, which classifies individuals based on the values of their identified attributes. Generally, the algorithm begins at a root node (Block 301). To traverse the decision tree, the algorithm poses a series of attribute-based questions (e.g., Blocks 302, 305, and 306). This process continues iteratively, potentially evaluating all key differentiating attributes identified earlier (Block 102), subject to model optimization techniques.

To better illustrate the structure of the algorithm in FIG. 3, consider an example where only two attributes are used:
1. “Is the person wearing an oversized coat?”
2. “Is the person sitting on the ground?”

The algorithm starts at the root node (Block 301) and evaluates the first attribute (Block 302):

If the answer is “yes”, the algorithm follows the yes-branch (Block 303); or

If the answer is “no”, it proceeds along the no-branch (Block 304).

From each of these branches, the algorithm evaluates the second attribute:

In the yes-branch path, Block 303 evaluates “Is the person sitting on the ground?” (Block 305) and processes the following two situations respectively:

If “yes”, the path proceeds to the yes-yes branch (Block 307); or

If “no”, it proceeds to the yes-no branch (Block 308).

On the other hand, in the no-branch path, Block 304 evaluates the same second attribute (Block 306) and processes the following two situations respectively:

If “yes”, the path proceeds to the no-yes branch (Block 309); or

If “no”, it proceeds to the no-no branch (Block 310).

If more than two attributes are identified, the same binary branching process continues. Each additional attribute introduces a new decision point, further splitting each existing branch into two new branches labeled with the prefix of the previous path followed by “-yes” or “-no,” respectively.

The leaf nodes of the tree (Block 311) represent the final classification outcomes. Each leaf node corresponds to a unique combination of yes/no responses to the attribute-based questions. Using the two-attribute example, the decision tree will include four possible leaf nodes formed from four distinct paths:
(yes, yes)—Block 307
(yes, no)—Block 308
(no, yes)—Block 309
(no, no)—Block 310

When the decision tree evaluates a larger number of attributes (e.g., approximately a hundred key differentiating attributes), the resulting leaf nodes will show a wide distribution of yes/no combinations. Leaf nodes with predominantly “yes” responses are more likely to be classified as “Homeless” by the pre-trained model, while those with mostly “no” responses are likely classified as “Not Homeless”. For individuals exhibiting mixed attributes, the trained machine learning model, whether based on a decision tree or an alternative architecture such as a neural network, can incorporate labeled training data to refine and improve classification accuracy.

More on Prompt Engineering (Block 103) with reference to FIG. 4 is explained below. FIG. 4 provides a detailed view of the Prompt Engineering step outlined as Block 103 in FIG. 1. In this step, labeled attributes are translated into structured prompts that guide LLM to focus on specific visual features within an image.

FIG. 4 shows an example of the prompt engineering process for attribute extraction with steps of Attribute Extraction, Prompt Creation, LLM Model Processing and Classification Output, as explained below:

Attribute Extraction (Block 401): In this step, the objective is to generate high-quality attributes that serve as key differentiators between homeless and non-homeless individuals. Generally, there are two approaches:
(1) Attributes may be manually defined by domain experts or individuals with sufficient knowledge of the problem domain; and
(2) Alternatively, attributes can be refined iteratively by running the process outlined in FIG. 1 multiple times with increasing volumes of test data. This iterative refinement enables progressive enhancement of attribute coverage to better represent real-world conditions.

Prompt Creation (Block 402): Once attributes are identified, prompts are constructed either manually or automatically through code, using the attribute inputs. For example, given the attribute “Is the person wearing an oversized coat?”, a corresponding prompt might be: “Does the person in this image have a dirty, oversized coat with a hood?” Prompts may follow the form of a question based directly on an attribute, or they may combine multiple related attributes into a single prompt for richer context.

LLM Model Processing (Block 403): In this step, a multimodal large language model (LLM) is invoked using the prompts generated in Block 402. The model processes the prompts and provides responses based on the visual data associated with each input.

Classification Output (Block 404): Finally, the outputs from LLM API calls are collected. These outputs are designed to answer the binary attribute-based questions (i.e., yes/no) posed via the prompts. The resulting set of responses helps populate a structured representation of the image based on the identified attributes, which can then be used for further classification and analysis.

Now, more on the Definition of Anomaly Detection is described. In the context of identifying homeless individuals, the objective of the algorithm is clearly defined: to detect members of a specific subgroup, those experiencing homelessness. However, the same anomaly detection framework can be applied to any target subgroup relevant to a given application.

For example, in crime detection or deterrence scenarios, such as those managed by security companies or law enforcement agencies, the subgroup of interest may consist of individuals exhibiting suspicious behavior or characteristics indicative of potential criminal activity. Evidence for such classification may include the presence of dangerous objects (e.g., weapons), or attire commonly associated with criminal intent (e.g., wearing a ski mask on a hot day in a location far from any ski areas). More detailed examples of such cues are provided later in the specification to avoid interrupting the current flow of description.

In a completely different application, such as identifying high-value customers in real time based on surveillance footage from shopping areas, the same anomaly detection framework can be employed. Here, the term anomaly refers to the fact that the target group is typically small in number and characterized by attributes that differ significantly from the general population. These distinguishing features can be incorporated into the GPT-based model using the algorithms described above.

What happens when the target subgroup is not clearly defined in advance? In such cases, the goal may shift toward identifying individuals who differ significantly from the majority. Once such anomalies are detected, domain experts can review and assign labels to the newly discovered subgroups, enabling further refinement and application, for example, in security surveillance.

In the context of shopping malls, such subgroups might include security personnel, janitorial staff, delivery workers, or maintenance personnel. In a corporate campus, the identified subgroups might include security guards, gardeners, shipping personnel, food delivery staff, and visitors. Recognizing and distinguishing these roles can be valuable for security teams responsible for monitoring the premises, enabling more targeted surveillance and response strategies.

Referring now to FIG. 5, an anomaly detection algorithm for identifying outliers in the dataset is shown. This algorithm addresses anomaly detection without a predefined target group, as explained in detail below.

To address the challenge of anomaly detection when the target group is not predefined, but instead, emerges based on patterns observed in reference data collected over time from the same premises, we introduce the following conceptual abstraction, detailed in the next subsection.

In the domain of document search and retrieval, outlier detection has been extensively studied, particularly for identifying documents that are significantly different from the rest in a dataset. This concept can be applied to anomaly detection by treating individuals (and any objects they possess) as analogous to “documents,” and by identifying outliers among a population based on their attributes.

To implement this approach, a set of binary attributes is first defined, using the mechanisms discussed earlier. For example:
A person missing a badge may be labeled as “badge-missing”, while those wearing badges are labeled “badge-present”;
Age-related attributes could be defined as “age-old” vs. “age-young”; and
Hairstyle could be classified as “hair-long” vs. “hair-short.”

These binary attributes form a structured feature set, enabling the model to distinguish individuals based on observable characteristics.

Once these attributes are assigned, any suitable algorithm from the information retrieval literature can be applied to detect the individual who is most distinct from the rest, referred to here as the “outlier person.” This transformation, from person to structured document, followed by outlier analysis, enables identification of individuals whose attributes deviate significantly from the norm.

FIG. 5 illustrates a process executed in Block 50 for outliers. The visualization demonstrates how individuals are plotted based on attributes such as age or badge presence, and how those deviating from the reference group are flagged as outliers. This process includes steps of Attribute Assignment, Outlier Detection Algorithm, Outlier Flagging and Further Classification as described below:

Attribute Assignment (Block 501): Each individual is represented as a “document” containing assigned attribute-values. For instance, “badge_present” may be added as a keyword for an individual wearing a badge, while “badge_missing” would be assigned to one without a badge.

Outlier Detection Algorithm (Block 502): Any established algorithm from the outlier detection literature may be employed to identify anomalous documents within the set. These correspond to individuals with rare or significantly distinct attributes.

Outlier Flagging (Block 503): If a given document (i.e., individual) is identified as an outlier by the algorithm in Block 502, the corresponding person is flagged as an anomaly.

Further Classification (Block 504): Domain experts review the results and may refine the model by introducing additional attributes (i.e., adding new “words” to the document representation). This post-processing step supports iterative improvement and more nuanced classification.

Collection of training data and customization of models based on location input and time input are essential to Prompt Engineering. These processes are explained below with reference to FIG. 6.

With respect to collection of training data, there are several methods for collecting training data that includes images of homeless individuals and regular individuals. One common method is through keyword search via search engines such as Google. When performing a search, the image tab is selected to retrieve images that match the search query. Although the labels in the search results often align with the keywords used, some manual corrections may be necessary. Additional keywords can be generated by feeding images of homeless individuals into an LLM and using the model's descriptions to gather further images. For example, the LLM may generate descriptions such as “Wearing a dirty, oversized coat with a hood” or “Pushing a shopping cart outside a shopping area with multiple garbage bags full of belongings,” which can be used to refine and expand the image dataset.

Another method involves collecting real-world data directly from public spaces. This approach is beneficial as it ensures that the data is representative of various environments and avoids deployment bias. It is important, however, to ensure that the appropriate legal rights are obtained for taking and using photographs in public spaces. Additionally, it is critical to note that while the model may be influenced by the collected data, it is understood in the machine learning community that the model itself does not disclose any specific data it has been trained on.

A third method for data collection involves gathering images from deployed customers. The data collected in different environments can vary, and this variance provides useful insights for customizing the model to specific locations. For example, a corporate campus may feature employees in white-collar attire, while a university campus will primarily include students in casual or academic clothing. A shopping plaza may have a wide variety of shoppers, with the clothing styles differing significantly based on the location, such as high-end shopping areas versus lower-end ones. These diverse datasets provide a rich source of images to train the model for better accuracy in detecting homeless individuals in different environments.

With respect to customization of models and prompt engineering based on location and time, data collected from specific environments can be leveraged in two primary ways. First, it may be advantageous to develop customized models tailored to the characteristics of a particular location or environment. For example, a corporate campus could benefit from a model trained specifically on its own data, potentially achieving greater accuracy than a general-purpose model.

Second, after deployment, such as when security robots are introduced into the environment, the model can be incrementally fine-tuned using images collected post-deployment. This allows the model to continuously adapt to the real-world conditions of its operational setting and improve over time.

The distribution of individual types may vary significantly, even within the same physical premises. For instance:
A corporate campus is likely to observe employees during rush hours and lunch breaks, while janitorial staff may be captured at off-peak times;
On a university campus, faculty and staff typically appear early in the morning, while students dominate images later in the day; or
In a shopping plaza, homeless individuals may be more likely to appear during off-hours, such as late at night or after businesses have closed.

To address such variability, customized models can be trained not only based on location type but also based on temporal factors, including time of day, day of the week, and business versus non-business hours. This approach can be applied both in traditional machine learning pipelines and in optimizing prompt engineering strategies for use with, for example, GPT-like APIs.

FIG. 6 (Block 60) illustrates how detection models can be customized using both location and time as input parameters. For example:
On a corporate campus, the model might prioritize detecting employees during business hours;
In a shopping plaza, the model might focus on detecting homeless individuals during off-hours;
Location Input (Block 601) and Time Input (Block 602) are provided to the Model Customization Module (Block 603); or
The combination of these parameterized inputs feeds into the module to generate a Customized Detection Model (Block 604).

As a simplified example, one can think of this customization process as resulting in four separate sub-models:
Model-Company-Weekday: Trained on data from a corporate campus during weekdays.
Model-Company-Weekend: Trained on data from a corporate campus during weekends or holidays.
Model-Mall-Weekday: Trained on data from a shopping mall during weekdays.
Model-Mall-Weekend: Trained on data from a shopping mall during weekends or holidays.

In practice, these models can be implemented either as separate models or as a single parameterized model that dynamically adjusts its behavior based on input location and time metadata.

In Prompt Engineering, proper handling of misclassification and model refinement is critical to the success of the process. Post Processing and Iterative Improvement are explained below with reference to FIG. 7.

To continuously enhance the accuracy of the detection system, we propose an iterative refinement process focused on analyzing false negatives, instances where the system fails to identify a homeless individual. Each false negative is carefully examined to determine which characteristics may have contributed to the misclassification. From these insights, new attributes can be derived and incorporated into the model, improving its performance in future iterations.

The same refinement process can also apply to analyzing false positives, instances where the system mis-identifies a regular individual as a homeless individual. However, in the context of homeless people detection, the focus tends to be more on the false negatives in the early development stages.

The prompt engineering process begins with a labeled dataset, where each image is annotated with ground truth labels indicating whether the person depicted is homeless or not. The system then identifies a set of differentiating attributes, such as clothing, posture, or context. Once these attributes are established, an LLM, for example, GPT is used to extract their values from the entire dataset.

Next, a classification algorithm, such as a decision tree, is selected. This algorithm produces a set of rules based on the identified attributes, forming a Boolean decision structure. For each rule in the decision tree, a corresponding prompt rule is constructed. These prompt rules translate the decision logic into a format that GPT can interpret and apply to new, unlabeled images, enabling consistent and explainable classification based on known attribute patterns.

To improve overall detection accuracy, the system must analyze all types of misclassifications, both false positives and false negatives. A false positive occurs when a regular individual is mistakenly classified as homeless, while, on the other hand, a false negative occurs when a homeless individual is mistakenly classified as regular.

FIG. 7 (Block 70) illustrates the process for identifying and correcting such errors through iterative analysis and refinement, it includes steps of Misclassification Detection, Attribute Re-evaluation, New Attribute Identification and Model Update, as described below:

Misclassification Detection (Block 701): Misclassified examples are identified, either manually or with the assistance of semi-automated tools.

Attribute Re-Evaluation (Block 702): Each misclassified image is reviewed to reassess the effectiveness of existing attributes and uncover potential gaps.

New Attribute Identification (Block 703): Based on the analysis, new attributes are identified from candidate features uncovered in the previous step. This identification may leverage domain expertise or analytical tools that treat the misclassified data as new labeled examples.

Model Update and Iteration (Block 704): The refined set of attributes is used to generate an enhanced labeled dataset, which feeds into a retraining cycle. This updated model is then deployed, and the process can be repeated to achieve continued improvements.

This iterative framework ensures that the model evolves and adapts over time, driven by real-world performance and feedback from edge cases.

Anomaly detection may be enhanced through robot-human Interaction, as described below with reference to FIG. 8.

Integrating anomaly detection into a security robot system with dynamic navigation and conversational capabilities adds a unique layer of functionality. When the robot identifies an outlier individual using the anomaly detection algorithm, it autonomously navigates toward that person and initiates a conversation. If the individual attempts to walk away or flee, such behavior further indicates a potential security risk, and the model may be further enhanced with this recognized character accordingly.

As another example, when the person remains and engages with the robot, the system can leverage an enhanced Crime Detection and Deterrence System (CDDS) to analyze the individual's responses. This analysis helps verify their identity and intent, for example, by checking for a valid ID or badge, or determining whether their name appears in relevant databases for employees, visitors, or contractors.

FIG. 8 (Block 80) illustrates the architecture of the anomaly detection and robot interaction system. Images from multiple sources (Block 801) are first processed by the GPT-based Anomaly Detection Engine (Block 802), which identifies individuals exhibiting outlier behavior. The robot then initiates engagement with these individuals (Block 803), and their responses are analyzed in real time by the Crime Detection and Deterrence System (CDDS) (Block 804). The Robot Interaction Module communicates with both the Anomaly Detection Engine and the CDDS; therefore, bidirectional arrows are depicted between Block 803 and Block 802, as well as between Block 803 and Block 804. Conceptually, the Anomaly Detection Engine serves as an extension of the existing CDDS. Together, the CDDS and the Anomaly Detection Engine influence both the navigation and conversational behavior of autonomous mobile robots.

The system of anomaly detection and robot interaction is illustrated in FIG. 8. The components of this system are described below:

Data Sources (Block 801): Image inputs from diverse environments,

Detection Engine (Block 802): Identifies anomalies using GPT-based models,

Robot Interaction (Block 803): Controls movement and conversation with flagged individuals, and

Crime Detection and Deterrence System (Block 804): Detects crime behaviors and identify crime suspects with necessary deterrence actions.

The communication signals in Block 80 (FIG. 8) are described below:

Block 802 to Block 803 (Label 823): “Anomaly Flags/Engagement Triggers”. This represents the Anomaly Detection Engine sending signals to the Robot Interaction Module to initiate an interaction based on detected anomalies.

Block 803 to Block 802 (Label 832): “Interaction Feedback/Behavior Signals”. This reflects the robot sending real-time observations, conversational cues, or environmental data back to the Anomaly Detection Engine to refine or validate the anomaly detection logic.

Block 803 to Block 804 (Label 834): “Interaction Data/Observed Behavior”. This indicates the robot is sending real-time data, like verbal responses, gestures, or proximity cues, captured during engagement with flagged individuals to the CDDS for further analysis.

Block 804 to Block 803 (Label 843): “Risk Assessment/Behavioral Directives”. This suggests the CDDS is sending back its evaluation, such as threat levels, escalation instructions, or guidance for continued interaction, to inform the robot's next moves or responses.

Referring now to FIG. 9, an interaction flow between the security robot and the outlier person is shown. Building upon the architecture shown in FIG. 8, FIG. 9 (Block 90) illustrates the detailed interaction flow between the security robot and an individual flagged as an outlier by the anomaly detection system. This interaction flow process includes the various steps as described below.

Patrol (Block 901): In this step, a security robot starts the patrol in a predefined area for security and safety navigation.

A Group of People Walks by (Block 902): In this step, the security robot detects one or more people in the predefined area.

Identify Outlier (Block 903): In this step, a person identified as an outlier by the system.

Approach Suspect (Block 904): In this step, the security robot approaches the outlier suspect.

Is Suspect Cooperative? (Block 905): In this step an inquiry is made whether the suspect is cooperative in responding to the approaching security robot. A standard operating procedure (SOP) derived from the security guard company suggests that if the suspect runs away, or does not respond rationally to any inquiries from the security robot, we assume the suspect is not cooperative.

Verify Identity (Block 906): In this step, the security robot verifies the suspect's identity based on CDDS as well as local databases (such as verifying an employee, a contractor, or a visitor, etc.). In case the identity cannot be verified, our security robot can ask additional questions. For example, a visitor may not have been added to the visitor database if their host employee does not do the process in time. Depending on the SOP, the company can choose to send a cell text message to the host employee asking for real time verification.

Increase Security Threat Likelihood (Block 907): In this step, the process indicates that if the suspect is not cooperative with the security robot, the threat analysis (in Block 908) will increase the likelihood that the suspect is a security threat.

Is the Suspect a Security Threat? (Block 908): In this step, the process conducts a threat analysis taking inputs from different branches. If the branch comes from Block 906, then the result of Identity verification will be taken into account. At the end of this process, if the suspect is deemed as a security threat, the process will be directed to Block 909 for further actions, otherwise, the process will be directed to the end and exits awaiting for the next operation cycle to resume.

Notify Head Operator (Block 909): In this step, as the suspect is deemed a security threat, the process will notify the head operator. After the human intervention by the head operator is completed, this operation cycle will end and exits awaiting the next operation cycle to resume.

In the present invention, throughout the description of the various innovative elements in connection with making decision with respect to the attending circumstances the security robot is facing, visual cues are employed as an essential tool for the process. In this section, we provide a list of visual cues commonly associated, in a behavioral profiling or forensic context, with criminal activity or individuals under suspicion. These cues can be based on clothing, body language, carried objects, contextual anomalies, and environmental interactions, as described below.

Carried Objects: These are items that may be associated with criminal intent depending on context and behavior, for example,
Weapons: Guns, knives, batons, or makeshift weapons (e.g., pipes, crowbars)
Concealment tools: Large duffel bags, backpacks, oversized jackets or coats (especially in warm weather)
Lock-breaking tools: Crowbars, bolt cutters, screwdrivers, lock picks
Containers: Gasoline canisters, suspicious packages, large suitcases in unusual places
Disguises: Masks, gloves, sunglasses (especially at night or indoors)

Clothing & Apparel Cues: Outfits or attire combinations that raise suspicion due to incongruity or concealment purposes, for example,
Concealing attire in inappropriate weather, such as ski masks, balaclavas, or hoodies tightly drawn over the face in warm weather, heavy coats or layered clothing on hot days.
Face-obscuring accessories, such as dark sunglasses at night or indoors, scarves, bandanas, or hats pulled low over the face.
Quick-movement attire, such as athletic wear, running shoes, lightweight outfits possibly chosen to evade quickly.
Matching or uniform-style outfits, such as matching attire among a group (e.g., all-black clothing), which may indicate coordination.
Gloves worn out of context, such as full gloves in summer or indoors (avoiding fingerprints).

Body Language & Posture: Behavioral cues often flagged in surveillance or security contexts, for example,
Nervous or evasive actions, such as avoiding eye contact with security or cameras, constantly looking over shoulders, adjusting clothing frequently (as if hiding something).
Loitering or pacing, such as staying in one place without purpose, especially near exits, ATMs, or high-value areas, repeatedly walking past the same spot or surveilling a location.
Walking style, such as limping or walking unusually (may suggest concealed items), hands kept in pockets for extended time in public or busy areas.

Environmental Incongruity: Mismatch between individual behavior or appearance and the surrounding context, for example,
Presence in restricted or unusual locations, such as lurking near emergency exits, stairwells, rooftops, or utility access areas.
Apparel mismatch with activity/location, such as wearing hiking boots and carrying a large backpack in a shopping mall, wearing construction gear without being near an active work site.
Group coordination, such as two or more individuals entering a location separately but synchronizing behavior once inside (common in theft scenarios).

Interaction Patterns: Observed actions that may suggest coordination or suspicious intent, for example,
Signaling, such as subtle hand gestures or head nods between individuals, use of earbuds or Bluetooth headsets possibly for remote coordination.
Camera awareness, such as actively avoiding surveillance cameras or checking their placement.
Shadowing behavior, such as following individuals or security guards closely, sometimes mimicking their routes.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A method for detecting anomalous individuals in image data without
predefined classes, the method comprising:
extracting a plurality of attribute values for each individual in a set of images, using prompt-engineered queries submitted to a large language model or a multimodal large language model, wherein the attribute values include binary or categorical attributes;
generating a structured representation of each individual based on the extracted attribute values;
computing a similarity or distance metric between the structured representations of individuals to determine a deviation of each individual's attribute profile from the other;
applying an outlier detection algorithm to identify individuals whose attribute profiles deviations exceed a predefined threshold relative to the group; and
flagging the identified individuals as anomalies for further review or processing.

2. The method of claim 1, wherein the outlier detection algorithm is selected from the group comprising k-nearest neighbors (k-NN), local outlier factor (LOF), and one-class support vector machine (one-class SVM).

3. The method of claim 1, wherein the extracted attribute includes at least one of: posture, clothing type, presence of accessories, or visual context from the background environment.

4. The method of claim 1, wherein the predefined threshold for deviation is determined statistically based on the distribution of similarity scores among the individuals.

5. The method of claim 1, further incorporating a limited set of labeled examples to adjust the sensitivity of the outlier detection algorithm.

6. The method of claim 1, wherein the large language model used for attribute extraction is a multimodal transformer configured to process both text and image inputs.

7. The method of claim 1, wherein the individuals comprise objects, and the anomalies are detected among objects rather than individuals.
